(19) United States
(12) Patent Application Publication
(10) Pub. No.: US 2005/0211962 A1
(43) Pub. Date: Sep. 29, 2005

(54) Nail pulling hammer

(76) Inventor: John B. Atkinson, Orange, CA (US)

Correspondence Address: Snell & Wilmer L.L.P., 1920 Main Street, Suite 1200, Irvine, CA, 92614-7230, US

(21) Appl. No.: 11/092,213

(22) Filed: Mar. 29, 2005

Related U.S. Application Data
(60) Provisional application No. 60/556,696, filed on Mar. 29, 2004.

(51) Int. Cl. B66F 15/00

(52) U.S. Cl. 254/26 R

(57) ABSTRACT

A hammer with a conventional open V-claw that has an aperture in the arm of the V-claw small enough so as not to interfere with the standard operation of the hammer and large enough to accept bodies of nails. When a nail body is exposed and cannot be pulled by the conventional V-claw, the body of the nail can be moved into and gripped by the aperture in the claw. When the hammer is then moved in a conventional nail removing motion, pressure is put on two sides of the nail allowing the hammer to firmly grip the body of the nail and then pull the nail out with ease. In some instances, the nail will be grasped using both the claw aperture and a hook extending from a side of the hammer.

### CROSS-REFERENCES TO RELATED APPLICATIONS

This application claims the benefit of Provisional Application No. 60/556,696, filed Mar. 29, 2004, herein incorporated by reference in its entirety.

### FIELD OF THE INVENTION

The present invention relates generally to methods and apparatus for pulling nails, particularly clawed hammers.

### BACKGROUND OF THE INVENTION

Many attempts have been made to provide methods and apparatus that facilitate nail removal. Examples can be found in the following issued U.S. Patents, each of which is herein incorporated by reference in its entirety: U.S. Pat. Nos. 559,049, 30,786, 724,542, 1,117,465, 1,425,369, 1,535,685, 1,792,437, 2,557,045, 3,885,772, 3,963,215, 4,482,132, 4,533,116, 4,561,635, 4,561,635, 4,776,568, 5,060,911, 5,002,257, 5,622,352, 5,674,002, and 6,032,927.

Unfortunately, prior attempts to provide methods and apparatus that facilitate nail removal have not provided a solution that is optimal for all situations. In particular, they have not provided a clawed hammer that provides the functionality and ease of use of the methods and apparatus described herein.

### SUMMARY OF THE INVENTION

The present invention is directed to a clawed hammer that provides all the functionally generally provided by such a hammer, but that also include a mechanism for gripping a nail that: (a) does not significantly add to the size or weight of the hammer; (b) does not unnecessarily complicate formation of the head of the hammer; (c) utilizes the leverage available from the existing claw; (d) provides at least two points of contact with the nail along a line extending radially from an axis about which the hammer is being rotated to pull a nail; and/or (e) has two, and possibly three, nail pulling modes that can all be used without excessive movement of hammer.

In an exemplary embodiment, the invention is a hammer with a conventional open V-claw that has an aperture in the arm of the V-claw small enough so as not to interfere with the standard operation of the hammer and large enough to accept bodies of nails. When a nail body is exposed and cannot be pulled by the conventional V-claw, the body of the nail can be moved into and gripped by the aperture in the claw. When the hammer is then moved in a conventional nail removing motion, pressure is put on two sides of the nail allowing the hammer to firmly grip the body of the nail and then pull the nail out with ease. In some instances, the nail will be grasped using both the claw aperture and a hook extending from a side of the hammer.

In another exemplary embodiment, the invention is a hammer including a claw having first and second arms separated by an open first end of a channel and coupled together adjacent a closed second end of the channel. The hammer comprises a first aperture extending into or through the first or second arm, the aperture being positioned near the first end of the channel, and the aperture being shaped and positioned to have a first nail contacting point and a second nail contacting point along a line perpendicular to an axis of rotation of the hammer.

In still another exemplary embodiment, the invention is a clawed hammer for use in removing a nail comprising a first nail contacting surface, a second nail contacting surface, and a third nail contacting surface. The first, second, and third contacting surfaces are positioned to simultaneously extend through or be within half a nail's body diameter of an imaginary reference plane. An air gap separates the first and second contacting surfaces; and an air gap separates the third contacting surface from a point midway between the first and second contacting surfaces.

In some embodiments, the invention is a standard claw hammer head mounted on one end of a handle. The hammerhead may be a standard size with a round striking surface used for hammering nails and may or may not have a V-claw used for removing and pulling out nails. The hammer of the present invention includes apertures in the hammer claws, which are positioned to apply pressure to the nail in two directions. The apertures in the center of the V-claws can capture nails in the same way. The apertures in the V-claws can be a part of any hammer and can be located on the inside, the outside or in the center of the V-claws. And these apertures in the claws can be numerous and located high or low in the claw.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a partial perspective view of a hammer in accordance with a first embodiment of the invention.

FIG. 2 is a detail view of a notch type nail receiving aperture of the hammer of FIG. 1.

FIG. 2A is a detail view of a second notch type nail receiving aperture of the hammer of FIG. 1.

FIG. 3 is a detail view of a hole type nail receiving aperture of the hammer of FIG. 1.

FIG. 4 is a partial cutaway bottom view of the hammer of FIG. 1.

FIG. 5 is a partial cutaway side view of the hammer of FIG. 1.

FIG. 6 is a partial cutaway side view of the hammer of FIG. 1.

FIG. 7 is a partial perspective view of a hammer in accordance with a second embodiment of the invention.

FIG. 8 is a partial perspective view of a hammer in accordance with a third embodiment of the invention.

FIG. 9 is a partial perspective view of a hammer in accordance with a fourth embodiment of the invention.

FIG. 10 is a partial perspective view of a hammer in accordance with a fifth embodiment of the invention.

FIG. 11 is a partial perspective view of a hammer in accordance with a sixth embodiment of the invention.

FIG. 12 is a rear view of a first alternative hammerhead configuration in accordance with an embodiment of the invention.

FIG. 13 is a rear view of a second alternative hammerhead configuration in accordance with an embodiment of the invention.

FIG. 14 is a rear view of a third alternative hammerhead configuration in accordance with an embodiment of the invention.

FIG. 15 is a rear view of a fourth alternative hammerhead configuration in accordance with an embodiment of the invention.

FIG. 16 is a rear view of a fifth alternative hammerhead configuration in accordance with an embodiment of the invention.

FIG. 17 is a rear view of a sixth alternative hammerhead configuration in accordance with an embodiment of the invention.

FIG. 18 is a rear view of a seventh alternative hammerhead configuration in accordance with an embodiment of the invention.

FIG. 19 is a rear view of an eighth alternative hammerhead configuration in accordance with an embodiment of the invention.

FIG. 20 is a rear view of a ninth alternative hammerhead configuration in accordance with an embodiment of the invention.

FIG. 24 is a partial perspective view of a hammer in accordance with an eighth embodiment of the invention positioned to remove a nail from a block of wood in accordance with an exemplary embodiment of the invention.

FIG. 25 is a partial perspective view of the hammer of FIG. 24 rotated to begin removal of a nail.

FIG. 26 is a partial perspective view of the hammer of FIG. 24 rotated to complete removal of a nail.

FIG. 27 is a partial perspective view of a hammer in accordance with a ninth embodiment of the invention.

FIG. 28 is a partial view of the hammer of FIG. 27.

FIG. 29 is a partial view of the hammer of FIG. 27 positioned to remove a nail from a block of wood in accordance with an exemplary embodiment of the invention.

FIG. 30 is a partial perspective view of the hammer of FIG. 27 rotated to begin removal of a nail.

FIG. 31 is a partial perspective view of the hammer of FIG. 27 rotated to complete removal of a nail.

### DETAILED DESCRIPTION OF THE PREFERRED EMBODIMENTS

Reference will now be made to the preferred embodiments of the invention, examples of which are illustrated in the accompanying drawings. While the invention will be described in conjunction with the preferred embodiments, it will be understood that these embodiments are not intended to limit the invention. On the contrary, the invention is intended to cover alternatives, modifications and equivalents, which may be included within the spirit and scope of the invention as defined by the appended claims.

In the following detailed description, numerous specific details are set forth in order to provide a thorough understanding of the present invention. However, it will be understood by one of ordinary skill in the art that the present invention may be practiced without these specific details. In other instances, well known methods, procedures, components, and circuits have not been described in detail so as not to unnecessarily obscure the important aspects of the present invention.

The present invention is directed to a clawed hammer that provides all the functionally generally provided by such a hammer, but that also include a mechanism for gripping a nail that: (a) does not significantly add to the size or weight of the hammer; (b) does not unnecessarily complicate formation of the head of the hammer; (c) utilizes the leverage available from the existing claw; (d) provides at least two points of contact with the nail along a line extending radially from an axis about which the hammer is being rotated to pull a nail; and/or (e) has two, and possibly three, nail pulling modes that can all be used without excessive movement of hammer.

In at least some embodiments, such a hammer will be suitable for use on a large range of nail sizes, and thus will be useable on nails from at least 2 penny size to 16 penny size, and possibly from 2 penny size to 75 penny size. In other embodiments, such a hammer may be limited to a smaller range of sizes such as any group of 2-7 adjacent sizes within the aforesaid ranges. Although described in relation to a claw hammer, and shown in relation to a particular type of clawed hammer, the methods and apparatus described herein can be incorporated into any claw hammer, and may also be used on other clawed apparatus that can be modified to include the features described herein.

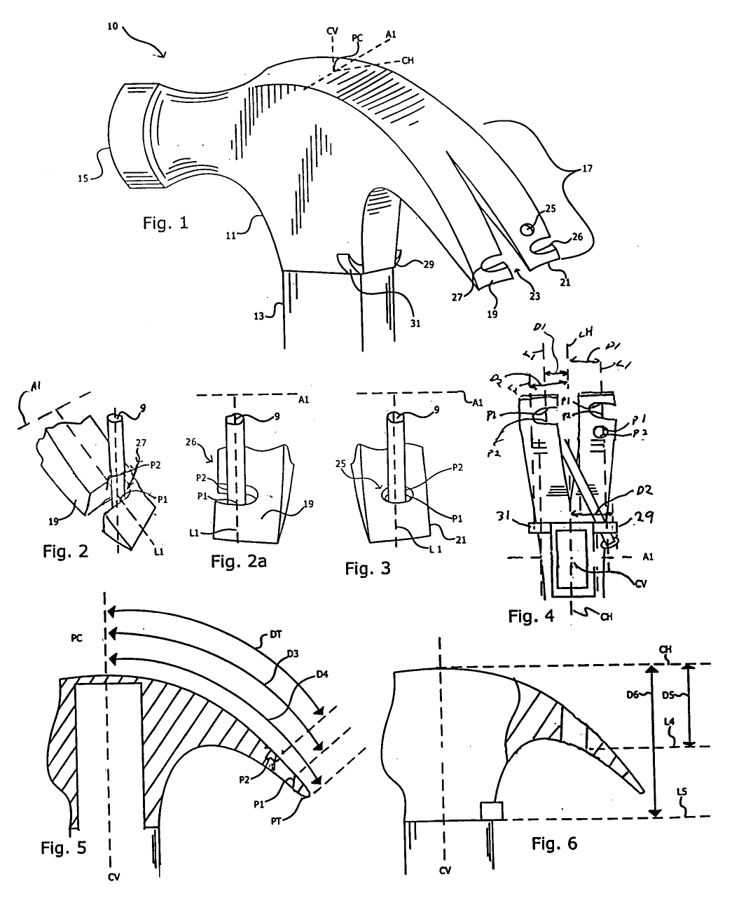

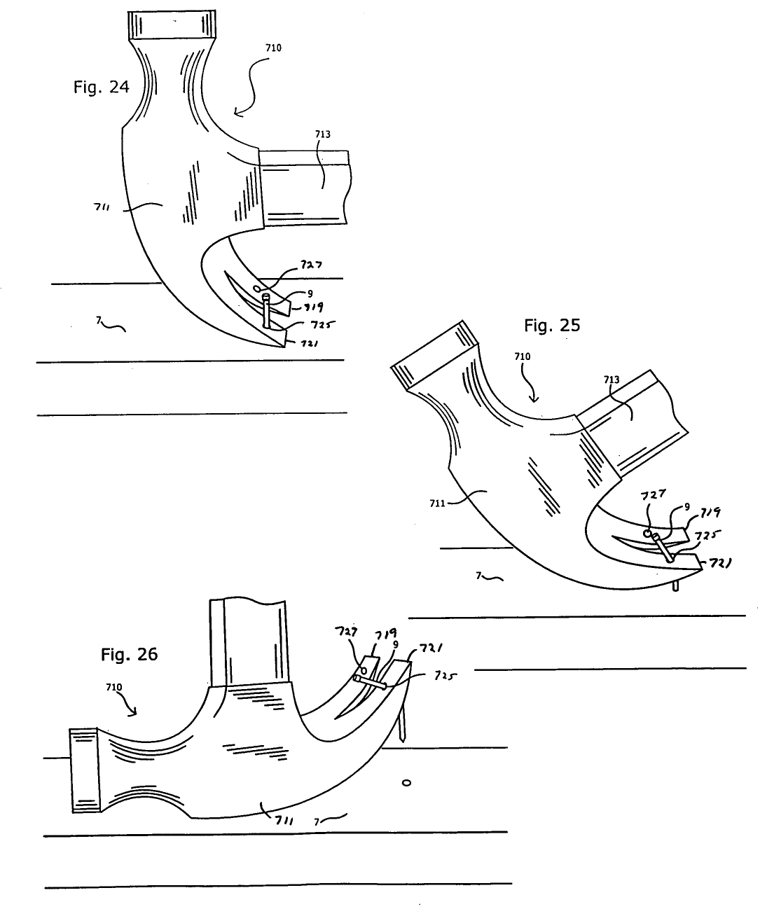

Referring to FIG. 1, a hammer 10 includes a head 11 and a handle 13. The head 11 includes a nail striking surface 15, and a claw 17. The claw 17 includes a first arm 19 and a second arm 21 separated by an open first end of a V-shaped channel 23 and coupled together adjacent a closed second end of the channel 23. The arm 19 includes a first aperture 27, and the arm 21 includes a second aperture 25 and a third aperture 26 where the apertures 25, 26, and 27 are positioned near the open end of the channel 23. The head 11 also includes upwardly opening hooks 29 and 31 positioned on and extending outward from opposite sides of the hammer. The hammer 10 is used to remove a nail (such as nail 9 of FIGS. 2, 2A, and 3) in a manner similar to that for the hammers 610, 710, and 810 described later, and shown in FIGS. 21-23, 24-26, and 27-31 which illustrate the removal of a nail 9 from a block of wood 7.

For clarity, various portions of the hammer will be described as if the hammer had a particular orientation with the head being up, the handle down, and the nail striking surface forward. In such instances the nail striking surface is the “front” of the hammer, and the claw side of the hammer is the “rear” of the hammer. The head 11 forms the “top” portion of the hammer, and the handle the “bottom portion”. The hooks 29 and 31 extend from the “left” and “right” sides of the hammer.

Also for clarity, although the handle need not be cylindrical, various portions of the hammer may be described in relation to a vertical centerline of the hammer which is an imaginary line extending vertically from a center point of a cross sectional area of a portion of the hammer head receiving the handle, and in some instances extending through a point on an opposite end of the handle. In FIG. 1, the line CV is the vertical centerline. Also for clarity, although the handle need not have symmetrical left and right sides, various portions of the hammer may be described in relation to a horizontal centerline of the hammer which is an imaginary line extending perpendicular to the vertical center line from a point where the vertical center line extends from the top of the hammer, and lying in a plane that includes the vertical center line and passes through the closed end of the channel separating the arms of the claw of the hammer. For a V-shaped channel, the plane including the horizontal and vertical center lines extends through the point of the V-shaped notch. In FIG. 1, the line CH is the horizontal centerline. Furthermore, although the hammer may be both rotated and translated during nail removal, various portions of the hammer may be described in relation to a line referred to as the axis of rotation of the hammer where the axis of rotation is a line perpendicular to both the vertical centerline and the horizontal centerline. In FIG. 1, line A1 is the line referred to herein as the axis of rotation of the hammer. The line A1 actually is the axis of rotation at least momentarily when it is tangent to a surface from which a nail is being removed.

In FIG. 1, the vertical centerline CV, the horizontal centerline CH, and the axis of rotation A1 form perpendicular axes while lines CV and CH lie in a plane separating left and right sides of the hammer, lines CV and A1 lie in a plane separating front and rear sides of the hammer, and the A1 and CH lines lie in a plane tangent to the top of the hammer which is the point PC on the hammer at which the lines CV, CH, and A1 intersect.

As shown in FIGS. 2, 2A, and 3, the apertures 25, 26, and 27 are each shaped and positioned to have a first nail contacting point P1 and a second nail contacting point P2 along a line L1 perpendicular to the axis of rotation A1 of the hammer. The aperture 25 is a hole extending vertically through the claw arm 21, the aperture 27 is a notch extending from the channel 23 into the claw arm 19, and the aperture 26 is a notch extending from the right, exterior, side of the claw arm 21 into the claw arm 21.

The apertures 25, 26 and 27 are near the open end of the channel 23 in that they are positioned closer to that end than to the closed end. Moreover, to provide better leverage, the apertures 25, 26 and 27 are positioned as near the rear of the hammer head as is possible without undesirably weakening either of the claw arms 19 and 21. As such, for at least one aperture and possible both apertures, the distance D3 along the top surface of the hammer from the vertical centerline (where it extends out of the top of the hammer at point PC) to the first nail contacting point P1 and the distance DT along the top surface of the hammer from the vertical centerline to a point on the end of the claw arm is preferably at least 0.5, more preferably at least 0.6, and most preferably at least 0.75. It is also preferred that, for at least one aperture and possible two or all three apertures, the distance D4 from the vertical centerline CV of the hammer to the second nail contacting point P2 and the distance DT from the vertical centerline CV to a point on the end of the claw arm is preferably at least 0.5, more preferably at least 0.6, and most preferably at least 0.75. The distances DT, D3, and D4 are illustrated in FIG. 5.

To reduce the chance of a nail slipping while being removed, it is preferred that both the horizontal distance between each hook (at least at a point of contact with a nail) and the vertical centerline, and the vertical distance between each hook (at least at a point of contact with a nail) and the horizontal centerline (i.e. the top of the hammer) be greater or lesser than the horizontal distance between the first and/or second nail contacting point and the vertical centerline and/or the vertical distance between the first and/or second nail contacting point and the horizontal centerline (i.e. the top of the hammer). This is illustrated in FIGS. 4 and 6 where D2 does not equal D1, and D6 does not equal D5. In some embodiments D2 will be less than D1 while in others it will be greater than D1. Similarly, in some embodiments D6 will be less than D5 while in others it will be greater than D5.

In some instances the head 11 may be a unitary cast metal head wherein in others it may be a head formed by milling a cast head. In other instances, it may be formed by some other process, and/or may be an assembly of unitary pieces such as a head having hooks 29 and 31 welded or adhesively bonded to the rest of the head 11. The head 11 and/or it components may advantageously be formed from steel. However, other embodiments may have a head and/or head components formed from some other material or combination of materials. Similarly, the handle 13 may comprise any reasonable size or shape, may be a single piece or an assembly of pieces, and/or may comprise a single material or a combination of materials. In many instances, using a wood, metal, or fiberglass handle may prove advantageous.

In preferred embodiments the head 11, handle 13, and nail striking surface 15 are all sized and dimensioned similarly to previously known hammers.

In some instances, a claw arm may be reinforced adjacent an aperture, and/or a surface of the aperture may be shaped, textured, or treated to facilitate use of the aperture to grip a nail and/or to prevent failure of a claw arm during nail removal.

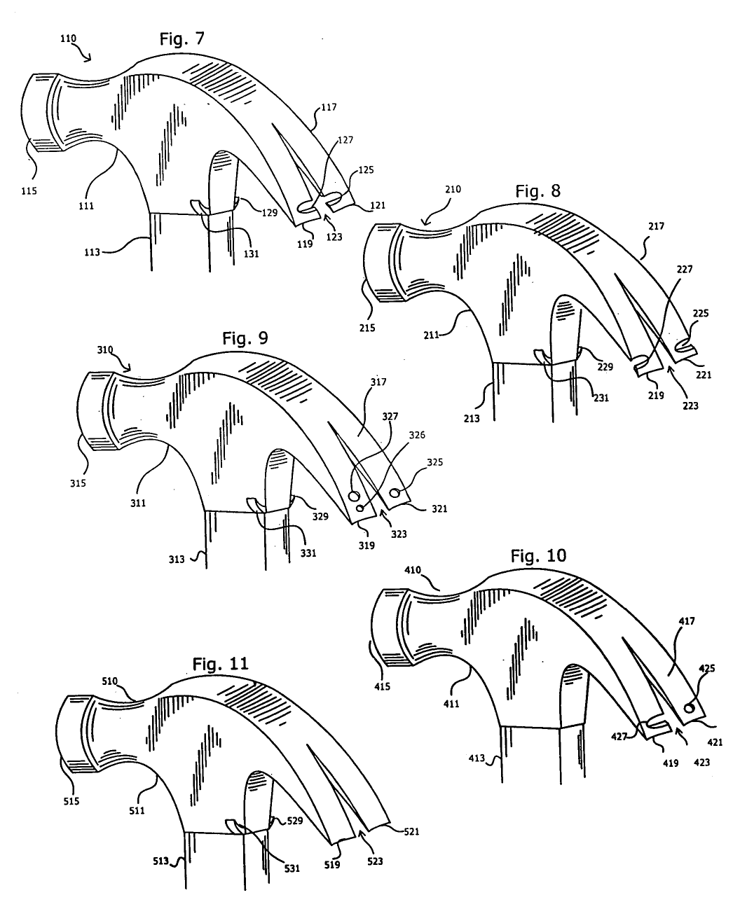

As illustrated in FIGS. 7-11, various embodiments may include any combination of claw apertures and hooks. As such, the embodiments of FIGS. 7-9 include both hooks and apertures. The embodiment of FIG. 10 includes apertures but not hooks, and the embodiment of FIG. 11 includes hooks but not apertures. The elements of the embodiments of FIGS. 7-11 have numbers that match those of the elements of the hammer of FIG. 1 in regard to the last two digits of the reference numbers. As such, the embodiments 110, 210, 310, 410, and 510 include: heads 111, 211, 313, 411, 511, and 611; handles 213, 313, 413, 513, and 613; nail striking surfaces 215, 315, 415, 515, and 615; claws 217, 317, 417, 517, and 617; arms 219, 319, 419, 519, and 619 and 221, 321, 421, 521, and 621; V-shaped channels 223, 323, 423, 523, and 623; apertures 225, 325, 425, and 525, and 227, 327, 427, and 527; and hooks 229, 329, 529, and 629, and 231, 331, 531, and 631.

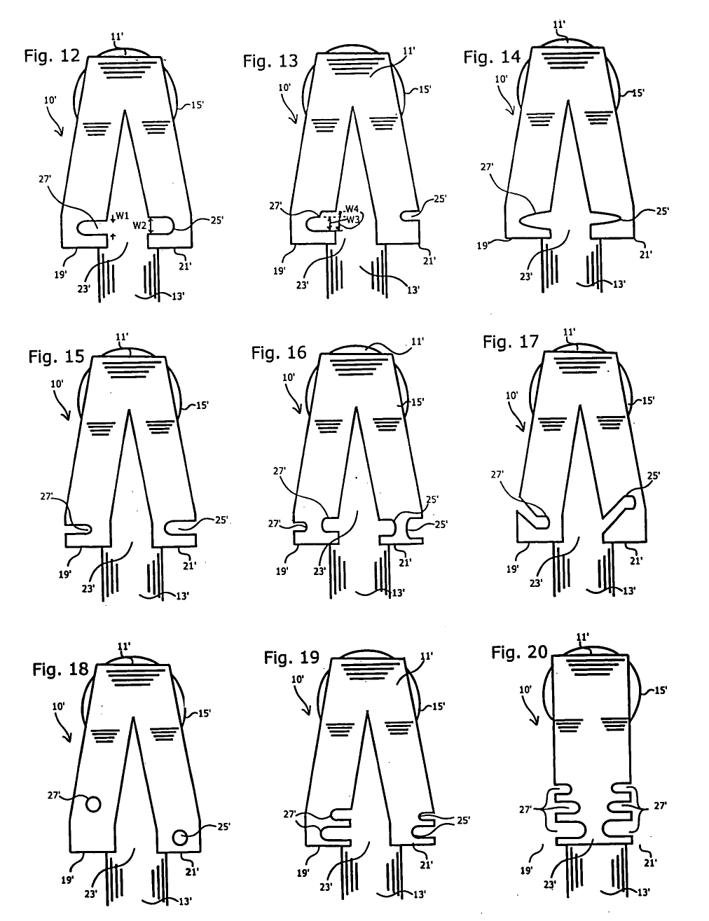

Moreover, the position number and size of apertures in the claw arms may vary between embodiments as illustrated by FIGS. 7-11 and also illustrated by FIGS. 12-20. For embodiments having multiple claw arm apertures, it may be advantageous to have those apertures be sized differently to facilitate removal of different sized nails. In other instances it may be advantageous to have apertures of equal sizes on both sides of the channel separating the arms to permit movement of the handle to the left or right to be used to remove a nail without causing the nail to slip out of an aperture.

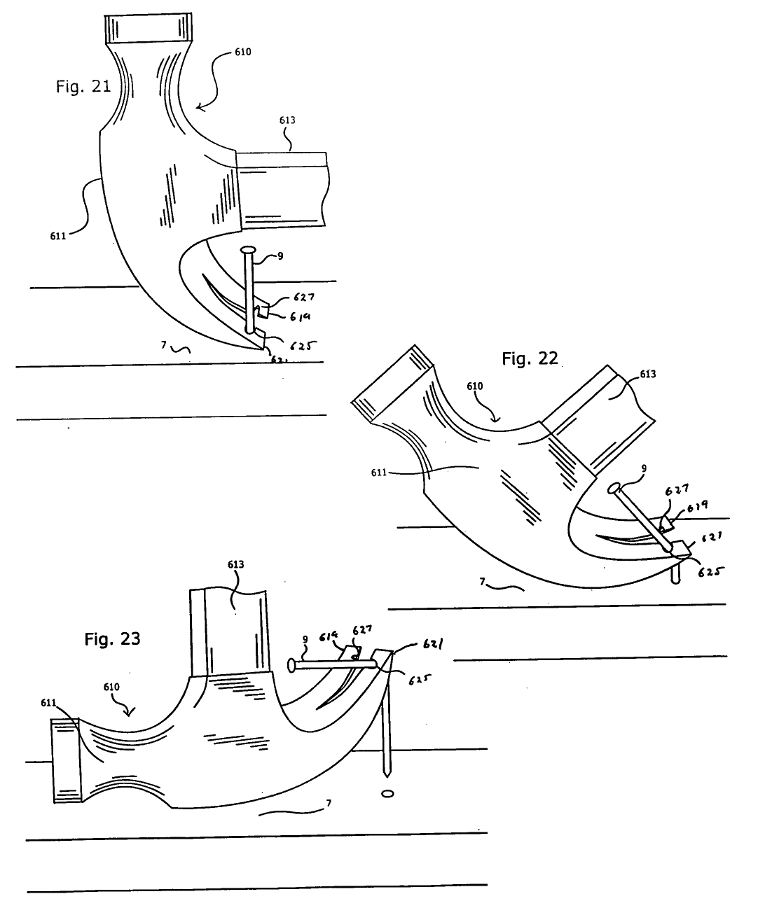

FIGS. 12-20 provide a rear view of some contemplated hammerhead configurations where alternate embodiments 10′ of the hammer 10 are shown. The alternate embodiment hammers 10′ each include a head 11′ a handle 13′, a nail striking surface 15′, arms 19′ and 21′, V-shaped channel 23′, and left and right arm apertures 27′ and 25′. In FIG. 12, left and right U-shaped apertures extending from the channel 23′ are provided having different widths W1 and W2 such that the aperture 27′ is suitable for use with smaller nails than the aperture 25′. In FIG. 13, the aperture 27′ itself comprises a two separate widths W3 and W4 such that the portion of the aperture furthest from the channel 23′ is more advantageously used with smaller nails than the portion adjacent to the channel 23′. In FIG. 14, the apertures 27′ and 25′ have rounded closed ends and tapering sides. As such, they each can accommodate a range of nail sizes. In FIG. 15, apertures 25′ and 27′ extend into the arms 21′ and 23′ from the left and right sides of the hammer rather than from the channel 23′. In FIG. 16, smaller width apertures 25′ and 27′ extend into the arms from the channel 23′, while larger width apertures extend from the left and right sides of the hammer. In some instances the inner apertures may be equally sized as may be the outer apertures, while in other instances combinations of apertures having different width may be used. In FIG. 17, the apertures 25′ and 27′ and slanted entry channels that terminate in rounded feet to facilitate sliding a nail through the entry channel and grasping it with a rounded foot. In FIG. 18, the apertures 25′ and 27′ comprise holes extending completely through the arms 19′ and 21′FIGS. 19 and 20 each show alternative arrangements of apertures where the apertures comprise a plurality of widths and lengths.

Referring to FIGS. 21-23, a nail 9 in a block of wood 7 is slid into the aperture notch 625 which was cut into the arm 621 of the arms 621 and 619 of the body 611 of the hammer 610. As illustrated, the nail 9 can be pulled from a board 7 like a regular nail. Pressure on the front and back of the nail 9 allows the arm 621 to grip the nail 9 close to the point where the nail 9 extends out of the wood 7. It should be noted that the notch 625 can be positioned to remove the nail 9 without having to move the hammer off of the nail 9. As such, if the V-shaped channel is initially used to pull the nail 9, switching to the notch 625 to grasp the nail only requires moving the hammer a distance which is less than the length of the V-shaped channel. Also in FIG. 21-23 is aperture 627.

Referring to FIGS. 24-26, a nail 9 in a block of wood 7 is slid into the aperture hole 725 which was drilled into a claw arm 721 of the body 711 of the hammer 710. As illustrated, the nail 9 can be pulled from a board 7 like a regular nail. Pressure on the front and back of the nail 9 allows the arm 721 to grip the nail 9 close to the point where the nail 9 extends out of the wood 7. Also in FIG. 24-26 are arm 719 and aperture 727.

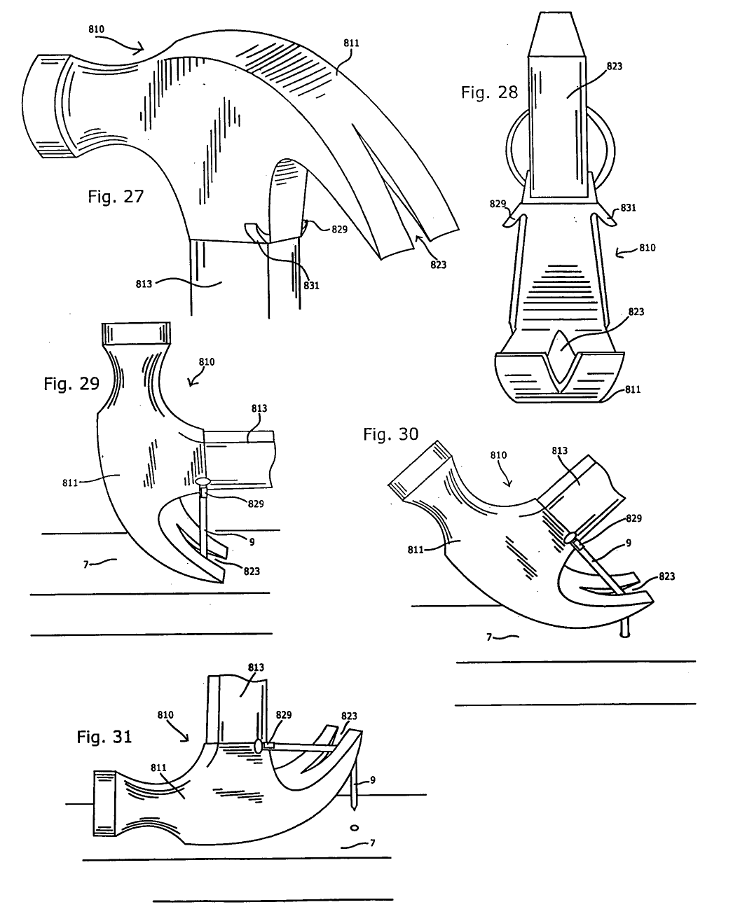

Referring to FIGS. 27-31, a hook/nail trap 829 on the side of the body 811 of the hammer 810 can grip the nail 9 forcing the sides of the V-shaped channel 823 to grip the nail 9 and pull it out of the wood 7. The hooks 829 and 831 point upward so ad to point downward when used to remove the nail 9, i.e. when the hammer 810 is inverted. Longer nails can be grasped by one of the hooks 829 and 8310 and forced in a direction at least partially across the centerline of the channel 823, forcing the sides of the channel 823 to grip the nail at a point on its body without use of a nail head. Having the hooks 829 and 831 extend out from the sides of the head 811 allow a portion of the nail 9 to pass along the side of the handle 813. This prevents the handle 813 from preventing longer nails from being pulled which might occur if the hook 829 extended from the rear of the head 811 in the same direction as the channel 823.

1. A hammer including a claw having first and second arms separated by an open first end of a channel and coupled together adjacent a closed second end of the channel, the hammer comprising:
a first aperture extending into or through the first or second arm, the aperture being positioned near the first end of the channel, and the aperture being shaped and positioned to have a first nail contacting point and a second nail contacting point along a line perpendicular to an axis of rotation of the hammer.

2. The hammer of claim 1 wherein the first aperture is a hole extending vertically through a claw arm.

3. The hammer of claim 1 wherein the first aperture is a notch extending from the channel into a claw arm.

4. The hammer of claim 1 further comprising a second aperture extending into or through the first or second arm, the aperture being positioned near the first end of the channel, and the aperture being shaped and positioned to have a first nail contacting point and a second nail contacting point along a line perpendicular to an axis of rotation of the hammer.

5. The hammer of claim 4 wherein the first aperture extends into or through the first arm, and the second aperture extends into or through the second arm.

6. The hammer of claim 5 wherein the first and second apertures are each a hole that extends vertically through a claw arm.

7. The hammer of claim 5 wherein the first and second apertures are each a notch that extends from the channel into a claw arm.

8. The hammer of claim 1 wherein a first ratio of the distance from a vertical centerline of the hammer to the first nail contacting point and the distance from the vertical centerline to the end of the claw arm, and a second ratio of the distance from a vertical centerline of the hammer to the first nail contacting point and the distance from the vertical centerline to the end of the claw arm are each at least X where X is 0.6.

9. The hammer of claim 8 wherein X is 0.75.

10. The hammer of claim 1 further comprising a first hook extending out from a first side of the hammer.

11. The hammer of claim 10 wherein the hook opens upward.

12. The hammer of claim 11 further comprising a second hook extending out from a second side of the hammer, opposite the first side of the hammer, the second hook opening upwards.

13. The hammer of claim 10 wherein the vertical distance between the first hook and the top of the hammer is greater than the vertical distance between the first nail contacting point and the top of the hammer.

14. The hammer of claim 13 wherein the horizontal distance between the first hook and vertical centerline of the hammer is greater than the horizontal distance between the first nail contacting point and the vertical centerline of the hammer.

15. The hammer of claim 13 wherein the horizontal distance between the first hook and vertical centerline of the hammer is less than the horizontal distance between the first nail contacting point and the vertical centerline of the hammer.

16. A hammer including a unitary head and an elongated handle, the head including a nail striking surface on a front side of the hammer, and a claw extending from a rear side of the hammer, the claw having first and second arms separated by an open first end of a V-shaped channel and coupled together adjacent a closed second end of the channel, the head comprising:
a first aperture extending into or through the first or second arm, the aperture being positioned near the first end of the channel, the aperture being shaped and positioned to have a first nail contacting point and a second nail contacting point along a line perpendicular to an axis of rotation of the hammer lying in a plane perpendicular to a centerline of the V-shaped notch and parallel to a centerline of the handle, and the aperture being a hole extending vertically through a claw arm or a notch extending from the channel into a claw arm;
a second aperture extending into or through the first or second arm, the aperture being positioned near the first end of the channel, the aperture being shaped and positioned to have a first nail contacting point and a second nail contacting point along a line perpendicular to the axis of rotation of the hammer, and the aperture being a hole extending vertically through a claw arm or a notch extending from the channel into a claw arm;
a first hook that opens upward and extends out from a left side of the hammer;
a second hook that opens upward and extends out from a right side of the hammer opposite the left side; wherein
a first ratio of the distance from a vertical centerline of the hammer to the first nail contacting point and the distance from the vertical centerline to the end of the claw arm, and a second ratio of the distance from a vertical centerline of the hammer to the first nail contacting point and the distance from the vertical centerline to the end of the claw arm are each at least X where X is 0.75;
the vertical distance between the first hook and the top of the hammer is greater than the vertical distance between the first nail contacting point and the top of the hammer;
the horizontal distance between the first hook and vertical centerline of the hammer is greater than the horizontal distance between the first nail contacting point and the vertical centerline of the hammer.

17. A clawed hammer for use in removing a nail comprising:
a first nail contacting surface, a second nail contacting surface, and a third nail contacting surface; wherein
the first, second, and third contacting surfaces are positioned to simultaneously extend through or be within half a nail's body diameter of an imaginary reference plane;
an air gap separates the first and second contacting surfaces; and
an air gap separates the third contacting surface from a point midway between the first and second contacting surfaces.
